(19) United States
(12) Patent Application Publication
(10) Pub. No.: US 2010/0235344 A1
(43) Pub. Date: Sep. 16, 2010

(54) MECHANISM FOR UTILIZING PARTITIONING PRUNING TECHNIQUES FOR XML INDEXES

(75) Inventors: Sivasankaran Chandrasekar, Menlo Park, CA (US); Anh-Tuan Tran, Vacaville, CA (US); Nipun Agarwal, Santa Clara, CA (US)

Correspondence Address: HICKMAN PALERMO TRUONG & BECKER/ORACLE, 2055 GATEWAY PLACE, SUITE 550, SAN JOSE, CA, 95110-1083, US

(73) Assignee: ORACLE INTERNATIONAL CORPORATION, REDWOOD SHORES, CA (US)

(21) Appl. No.: 12/403,153

(22) Filed: Mar. 12, 2009

(51) Int. Cl. G06F 17/30

(52) U.S. Cl. 707/713; 707/E17.014; 707/E17.044; 707/E17.054

(57) ABSTRACT

Techniques are provided for utilizing partition pruning for XML indexes. The computer-implemented method comprises storing XML documents in a document table, which is equi-partitioned with a corresponding index table, and wherein the partitioned document table and the partitioned index table can be searched using a query comprising a partitioning pruning directive.

### RELATED APPLICATIONS

This application is related to U.S. application Ser. No. 10/884,311, (Attorney Docket No. 50277-2512) entitled Index For Accessing XML Data, filed on Jul. 2, 2004 by Sivasankaran Chandrasekar, et al., the contents of which are herein incorporated by reference in their entirety for all purposes.

This application is related to U.S. application Ser. No. 09/406,482, (Attorney Docket No. 50277-0277) entitled Parallel Partition-Wise Joins, filed on Sep. 27, 1999 by Mohamed Zait, et al., the contents of which are herein incorporated by reference in their entirety for all purposes.

This application is related to U.S. application Ser. No. 10/944,170, (Attorney Docket No. 50277-2561) entitled Efficient Query Processing Of XML Data Using XML Index, filed on Sep. 16, 2004 by Ashish Thusoo, et al., the contents of which are herein incorporated by reference in their entirety for all purposes.

### FIELD OF THE INVENTION

The present invention relates to database systems, and in particular, to optimization of queries that access XML data stored in a database system.

### BACKGROUND

Database servers manage a database. A database comprises data and metadata that is stored on a persistent memory mechanism, such as a set of hard disks. Such data and metadata may be stored in a database logically, for example, according to relational and/or object-relational database constructs. Database Applications interact with a database server by submitting to the database server commands that cause the database server to perform operations on data stored in a database. A database command may be in the form of a database statement.

For the database server to process the database statements, the database statements must conform to a database language supported by the database server. One non-limiting database language supported by many database servers is SQL, including proprietary forms of SQL supported by such database servers as Oracle, (e.g. Oracle Database 10g). SQL data definition language (“DDL”) instructions are issued to a database server to create or configure database objects, such as tables, views, or complex data types.

### Database Servers for XML Data

Database servers have been adapted to store XML data. In a database server, an XML document may be stored in a row of a table, and nodes of the XML document may be stored in separate columns of the row. An entire XML document may also be stored as a lob (large object) in a column. An XML document may also be stored as a hierarchy of objects in a database, where each object is an instance of an object class and stores one or more elements of an XML document. Tables and objects of a database system that hold XML data are referred to herein as base tables or objects.

Database servers include many mechanisms that allow for powerful and efficient ways to query large collections of XML documents. For example, database servers that store XML documents may be configured to efficiently perform various XML operations. One type of XML operations is an operation allowing execution of queries over a collection of XML documents and using XML query languages, such as XQuery/Xpath. XML Query Language (“XQuery”) and XML Path Language (“XPath”) are standards for a query language, and can be used in conjunction with SQL to express a large variety queries. The term XML query is used to refer to queries that conform to: (1) an XQuery, XPath, or other XML language command, (2) SQL queries that may embed XQuery or XPath expressions, (3) queries of other languages, and (4) proprietary dialects of XQuery, XPath, SQL, or XML standard languages.

A database server may maintain a “logical index,” referred to herein as an XML index, which indexes a collection of XML documents. A logical index contains multiple structures that are cooperatively used to access a collection of XML documents. According to an embodiment of the present invention, a logical index includes a Path table, which contains information about the hierarchies of nodes in a collection of XML documents and may contain values of the nodes. The Path table may have columns for storing the nodes attributes, nodes identifiers and paths identifiers.

### Example of an XML Document Table and XML Path Table

Suppose we have an XML document comprising two rows of data, Row 1 and Row 2, having the following elements:
<a><b>12</b>
<z>55</z>

In the above example, Row 1 comprises elements <a>, and <b>, whereas Row 2 comprises an element <z>. In Row 1, the element <a> is a root of the element <b>. Suppose that the element <b> has a value of “12,” and suppose that the element <z>, in Row 2, has a value of “55.”

The above XML document may be represented in a graph as follows:

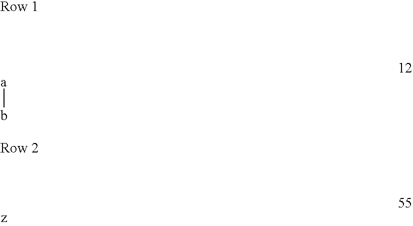

The above XML document may be also represented in an XML document table as follows:

TABLE 1
Example of an XML Document Table

| ROW NUMBER | CONTENT |
|---|---|
| Row 1 | <a> <b>12</b> |
| Row 2 | <z>55</z> |

The above XML document table may be also represented in a Path table (described in details in U.S. application Ser. No. 10/884,311) as follows:

TABLE 2
Example of a Path table

| ROW ID | PATH ID | ORDER KEY | LOCATOR | VALUE |
|---|---|---|---|---|
| R1 | /a | 1 | 1 | — |
| R1 | /a /b | 1.1 | 5 | 12 |
| R2 | /z | 1. | 20 | 55 |

The relationship between the XML document table and the Path table may be represented as follows:

TABLE 3
Example of an XML document table and a corresponding Path table

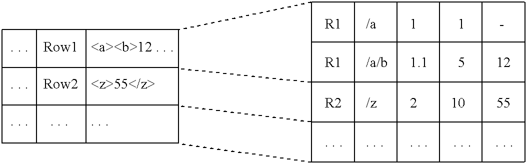

When a database server receives an XML query, the database server may rewrite the query to refer to the underlying database structures that store the XML data. Such rewrites may include rewriting the query to refer to the data structures already defined within the XML document table or the Path table. For example, because the Path table contains path identifiers (PATH ID), queries that request particular node names may by rewritten to derive the particular names directly from the data structures of the Path table, and thus, generating and storing of those names in separate data structures can be avoided. Described herein are techniques that allow for more efficient use of XML document tables and Path tables.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating equi-partitioned XML document table and Path table according to the present invention;

FIG. 2 is a flow chart illustrating a pruning technique for equi partitioned XML document table and Path table according to an embodiment of the present invention; and

FIG. 3 is a block diagram of a system upon which the techniques described herein may be implemented.

### DETAILED DESCRIPTION

In the following description, for the purposes of explanation, numerous specific details are set forth in order to provide a thorough understanding of various embodiments of the invention. It will be apparent, however, that the present invention may be practiced without these specific details. In other instances, well-known structures and devices are shown in block diagram form in order to avoid unnecessarily obscuring the present invention.

### Partitioning

To improve manageability of relational databases containing tables with a large amount of data and with potentially millions of rows, the database tables may be divided into partitions of a more manageable size. Partitioning allows subdividing a table containing data into smaller pieces, called partitions. Each partition may have its own name and may have its own characteristics.

The operation of dividing a table into partitions can be accomplished using various partition keys, and can be based on various partition criteria. A partition key is a key that is used to determine to which partition a particular record of data belongs. The partition key can be defined in terms of one or more attributes of the table. The partitions produced by this process are collectively referred to as a partitioned table. Each partition of the partitioned table has the same columns as the table prior to partitioning. Collection of all the partitions in the partitioned table includes all the data of the table prior to partitioning. However, each partition contains only a subset of the rows of the partitioned table.

Alternatively, the partition key may be derived from information not included in any of the columns of the document table. In some implementation, a database management system automatically generates, updates and maintains partition keys and the appropriate partitions using the partition keys.

Partitioning enhances the performance, manageability, and availability of a wide variety of applications, and helps reduce the total cost of ownership for storing large amounts of data. Further, partitioning allows the database objects to be managed and accessed at a finer level of granularity. Moreover, since it is entirely transparent, partitioning can be applied to almost any application without the need for potentially expensive and time consuming application changes.

The most common form of partitioning is a “range” partitioning. In the range partitioning, the data in a table is grouped according the “range” of values stored in one or more columns. Thus, the data falling into a first “range” of values of one or more columns may be stored in the first partition P1 of the partitioned table, the data falling into a second “range” of values of one or more columns may be stored in the second partition P2 of the partitioned table, and so forth. For example, one column of a table may store “date” values that indicate the month of the year, in which the particular data record was stored in the database. Since there are twelve months in a year, the table may be divided into twelve partitions, where the first partition P1 stores the data collected in January, the second partition P2 stores the data collected in February, and so forth.

Another form of partitioning is a “function” partitioning. Under function partitioning, the output value, computed for a partitioning function, dictates to which partition the row of data belongs. For example, a table may contain a column called “Department” (DEPT). If the row that has a DEPT column value that evaluates (using, for example, a hash function) to the hash value of, for example, “1,” that row of data may be stored in the partition P1, whereas the row with a DEPT column value evaluating to the hash value of “2” may be stored in the partition P2, and so forth. Function partitioning may be also implemented using other mechanisms, which may not require column evaluation of the partitioned table.

### Equi-Partitioning

Equi-partitioning involves at least a pair of partitioned tables, where one table is referred to as a master table and another table is a slave table. In equi-partitioning, each partition in the master table has a corresponding partition in the slave table, and vice versa. In addition, each row in the slave table has a corresponding row in the master table, and vice versa. In equi-partitioning, the master table partitions usually govern in which partition of the slave table the data rows are stored. For purposes of equi-partitioning, the rows in the Path table that index the nodes of a particular XML document correspond to the rows in the XML document table that store the XML document.

### Example of an Equal-Partitioning

Suppose that a particular XML document table was partitioned into three partitions, P1, P2, and P3. Suppose partition P1 contains data collected in year 2008, partition P2 contains data collected in year 2007, and partition P3 contains data collected in year 2006.

Further, suppose the Path table, which corresponds to the particular XML document table, was equi-partitioned with the XML document table. Therefore, each row of data in the partitioned XML document table may have one or more rows of corresponding data in the partitioned Path table. According to the example illustrated in TABLE 4 (below), Row r1 of data in partition P1 of the partitioned XML document table has two corresponding rows (Row pr1 and Row pr2) in the partitioned Path table.

TABLE 4
Example of an equi-partitioned XML document table and Path table

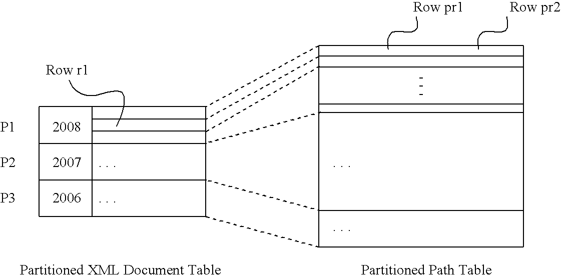

### Equi Partitioned Tables

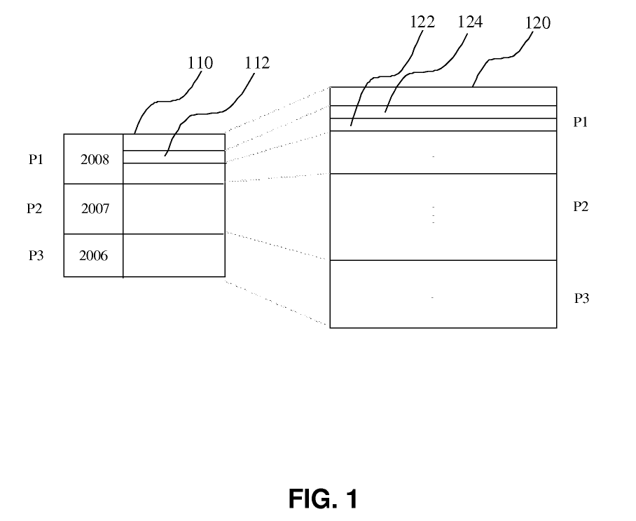

FIG. 1 is a block diagram illustrating an equi-partitioned XML document table 110 and Path table 120. The partition key of the XML document table 110 is the “date” data entry from the corresponding XML document. The partitioned Path table 120 comprises the data from the partitioned XML document table 110. In the illustrated embodiment, both, the partitioned XML document table 110 and the partitioned Path table 120 have partition P1, partition P2 and partition P3. In the XML document table 110, partition P1 comprises data collected during year 2008, partition P2 comprises data collected during year 2007, and partition P3 comprises data collected during year 2006. Thus, the partitioned XML document table 110 has the same number of partitions as the partitioned Path table 120.

The rows in the partitioned XML document table 110 correspond to the rows in the partitioned Path table 120. Each row of data in the partitioned XML document table 110 may have one or more rows of corresponding data in the partitioned Path table 120. For example, row 112 of data in partition P1 of the partitioned XML document table 110 has two corresponding rows (row 122 and row 124) in the partitioned Path table 120. According to another example, partition P1 in the partitioned XML document table 110 may have 100 rows (XML documents), wherein each of the rows 112 in the XML document table 110 has a number of rows 122, 124, etc., in partition P1 of the partitioned Path table 120. Therefore, the number of rows in a particular partition of the partitioned Path table 120 may exceed the number of rows in the corresponding partition of the partitioned XML document table 110.

According to an embodiment, equi-partitioning may be implemented using a partitioning function. A partitioning function defines the relationship between partitions of the master table and the slave table. For example, if the master table is partitioned by a “range,” value (i.e., where the master table is partitioned based on the range of values stored in a particular column of the master table), the partitioning function may define that the slave table is also partitioned by the “range” value. According to another example, if the master table is partitioned according to a list of some pre-defined values stored in various columns of the master table, the partitioning function may define that the slave table is also partitioned according to the list of the predefined values.

The equi-partitioned master and slave tables may share the same attributes. For example, a particular partition in the master table and the corresponding partition in the equi-partitioned slave table may have the same name. Hence, the same name may be used to identify the particular partition in the master table and the corresponding partition in the slave table.

According to another example, a particular partition in the master table and a corresponding partition in the equi-partitioned slave table may have the same ordinal number. For example, if a particular partition in the master table is the first partition in the master table, the corresponding partition in the equi-partitioned slave table may also be the first partition in the slave table. Therefore, the same ordinal number may be used to identify the particular partition in the master table and the corresponding partition in the slave table.

Simple rules may be applied to equi-partitioned master and slave tables. For example, if an operation, such as e.g. database DDL, or DML, is applied to a particular partition in the master table, then a similar or equivalent operation may be applied to the corresponding partition in the slave table. For instance, if a new row is inserted into the partition P1 of the master table, then a set of corresponding new rows may be inserted into the slave partition P1. According to another example, if a particular partition P2 in the slave table is split into two sub-partitions Pa and Pb, then the corresponding master partition P2 may also be split into two sub-partitions Pa and Pb, wherein the master sub-partition Pa corresponds to the slave sub-partition Pa and the master sub-partition Pb corresponding to the slave sub-partition Pb.

### Partition Pruning

Partition pruning improves computation of search queries by excluding from the computation those partitions that do not contain data relevant to the search. When a database server receives a request to perform an operation, the database server makes an execution plan of how the query should be executed. If the operation involves accessing a partitioned table, part of making the plan involves determining which partitions of the partitioned table can be excluded from the plan (i.e. which partitions need not be accessed to execute the query). The process of excluding partitions from the execution plan for a query is referred to as “partition pruning.”

For example, suppose an application defines a table containing a large number of records comprising product orders, and that the table has been partitioned by the “month” when the particular order was made. If the table containing the orders is partitioned by the “month” when the orders were made, the search query requesting orders placed, for example, in March, can be easily computed by accessing only the partition comprising product orders placed in March, and excluding all the other partitions (January, February, April, May, etc.).

The advantage of pruning partitions that contain data collected during the months irrelevant to the search is easily evident. For example, if the table had two years (2008-2009) of orders records data and the query requests only data collected in March of 2008, then the search query accesses only the partition storing the data from March of 2008, instead of accessing all twenty four partitions. Excluding, or pruning, the partitions that are irrelevant to the particular search speeds up the overall computation of the search query.

### Equi-Partitioning Pruning

According to one embodiment, a partition pruning may be applied to two equi-partitioned tables, such as a partitioned XML document table and a partitioned Path table.

One of the advantages of partition pruning of the equi-partitioned document table and the Path table is that the partitions irrelevant to the particular search can be excluded from the search. Pruning of equi-partitioned XML document table and Path table guarantees a smaller number of partitions that are actually searched when the search query is executed.

To accomplish the equi-partitioning pruning for equi-partitioned XML document table and Path table, the search query needs to be rewritten to indicate which partitions of the index table need to be searched before the query is actually executed. This may be accomplished using a partitioning pruning directive.

### Partitioning Pruning Directive

To take an advantage of the equi-partition pruning in the equi partitioned XML document table and Path table, the search query needs to be rewritten using a partitioning pruning directive.

Suppose a query is received. The query requests a count of all the records from the document table which were collected in the year 2007 or later, and in which a/b/ value is “5.” Using XQuery language, such a query may be written as follows:

| | |
|---|---|
| QUERY: | select count (*) |
| | From doc_able |
| | Where data >= 2007, and |
| | Extract value (/a/b) = 5 |

With equi-partitioning of the XML document table and the Path table available, computation of a query may be optimized by rewriting the query and using a partitioning pruning directive. The pruning directive specifies that if a particular partition in the master table is pruned, then the corresponding partition in the slave table needs to be pruned also.

According to an embodiment, the pruning directive may be expressed as a function F (doc table, path table, rowid), wherein “doc table” is the name of the XML document table, “path table” is the name of the Path table, and “rowid” is a data row identifier. Using this type of function, the “rowid” parameter may be used to identify a particular row in the XML document table. Then, the corresponding partition of the XML document table containing the particular row, and the corresponding partition in the equi-partitioned Path table can be identified. For example, if “rowid” indicates a name of the particular department “DEPT,” then, using the “rowid,” the row with the data pertaining to the DEPT may be identified in the XML document table. Then, the partition of the XML document table where the particular row of data was found can be identified. Then, since the XML document table and the Path table are equi-partitioned, the corresponding partition in the Path table may be identified as well.

According to an embodiment, the pruning directive may be expressed as a function F (master, slave, column_used_to_store_some_selected_rowids), wherein “master” is the name of the master table, “slave” is the name of the slave table, and “column_used_to_store_some_selected_rowids” is a column in the third table used to store one or more “rowids.” In this embodiment, the function F is executed to map the “rowids” to the partition numbers. For example, “column_used_to_store_some_selected_rowids” may point to a column that comprises “rowid1,” and “rowid2.” Thus, “rowid1” is used to identify the appropriate row in the master table, then the appropriate partition in the master table, and then the appropriate partition in the slave table. Subsequently, a similar sequence of identifications is repeated for “rowid2.”

According to an embodiment, the pruning directive may be expressed as a function F (doc table, path table, ROWID), wherein “ROWID” is a special keyword. ROWID is different from “rowid” and “column_used_to_store_some_selected_rowids”, described above. ROWID indicates that the directive F does not need to be evaluated. ROWID specifies how the “doc table” and the “path table” need to be pruned. If a particular master partition is pruned in some fashion, then the corresponding slave partition is pruned in the same fashion too. For example, the ROWID may indicate that if a particular partition in the master table is pruned based on pre-determined pruning criteria, then the corresponding slave partition is also pruned using the same pruning criteria.

In addition to indicating the pruning scheme to be applied to the equi-partitioned master and slave table, the pruning directive F may provide clues to a query optimizer to generate an execution plan with a partition-wise join established between the master and slave tables. For example, if as a result of pruning, all the partitions but P2, P4 and P6 are excluded from the execution plan, the resulting table's join will consist of only partitions P2, P4 and P6 of the master table and P2, P4 and P6 of the equi-partitioned slave table.

Referring again to the QUERY discussed above:

| | |
|---|---|
| QUERY: | select count (*) |
| | From doc_table |
| | Where data >= 2007, and |
| | Extract value (/a/b) = 5 |

Using the pruning directive, the above query may be rewritten as follows:

From doc_table (P1, P2), path_table
When data >= 2007 and
Pid = /a/b and
Value = 5 and
F (doc table, path table, rowid)

In this example, the pruning directive F specifies that for any partition pruned in the “doc_table,” the corresponding partition in the “path_table” is also pruned. For instance, if during compilation of a query execution plan, a query optimizer of the database server prunes the partition P1 from the XML document table 110 (depicted in FIG. 1), then, the query optimizer can also determine that it is necessary to prune the partition P1 from the Path table 120. Thus, pruning directives optimize execution of a query by indicating which partitions of the XML document table and the Path table may be excluded from computing the particular query.

### Location Data Using Partition Pruning Directive

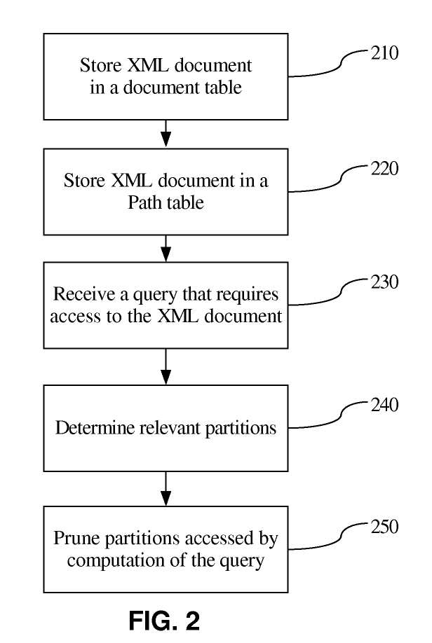

FIG. 2 is a flow chart illustrating a pruning technique for an equi partitioned document table and Path table according to an embodiment of the present invention. In step 210, an XML document is stored in a document table. Each XML document is divided into rows, and each row contains XML data. Each row of the XML document is stored in a separate row of the XML document table. An example of storing the XML document in the document table was provided above.

In step 220, the XML document is stored in a Path table. Each row of data from the XML document table is analyzed to identify individual paths within the row. Then, data from each row of data from the XML document table is organized according to the identified paths, and the paths are stored in the Path table. An example of the Path table was provided above.

According to an embodiment, the XML document table and the Path table are partitioned. Various partitions schemes may be implemented to partition the XML document table and the Path table. One of the partition schemes is equi-partitioning, where for each partition in the master table has a corresponding partition in the slave table, and where each row in the slave table has a corresponding row in the master table. This type of partitioning allows determining, for example, which partition in the Path table corresponds to the partition in the XML document table that holds a particular data from the XML document.

In equi-partitioned XML document and Path tables, the rows in the partitioned XML document table correspond to the rows in the partitioned Path table. However, each row of data in the partitioned XML document table may have one or more rows of corresponding data in the partitioned Path table. For example, as illustrated in FIG. 1, a partition P1 in the partitioned XML document table 110 has three rows, but has more then three corresponding rows in the corresponding partition P1 in the partitioned Path table 120.

In step 230, a query requiring access to the XML document is received. An example of a query was provided above.

In step 240, the search query is rewritten and a pruning directive is added to the search query. Based on the pruning directive, it is determined how the search query needs to be executed and which partition or partitions need to be searched. Such a determination may be made using the information about the partition key, such as the “date,” indicating, for example, when the XML document entries were made.

In step 250, the partitions required for the query computation are pruned so that only certain XML document table's partitions are selected and corresponding path table's partitions are selected. An example of partition pruning was provided above.

At times, there may be a need to take some of the XML document table's partitions off-line, and made them inaccessible to the end users. According to an embodiment, in response to taking the master table's partition offline, corresponding slave table partitions are taken off-line as well.

According to an embodiment, approaches disclosed herein may be implemented in a database system. A database management system (“DBMS”) manages a database. A database management system may comprise one or more database servers. A database comprises database data and metadata that is stored on a persistent memory mechanism, such as a set of hard disks. Database data may be stored in one or more data containers. Each container contains records. The data within each record is organized into one or more fields. In relational database management systems, the data containers are referred to as tables, the records are referred to as rows, and the fields are referred to as columns. In object-oriented databases, the data containers are referred to as object classes, the records are referred to as objects and the fields are referred to as attributes. Other database architectures may use other terminology. Database applications and clients interact with a database server by submitting to the database server commands that cause the database server to perform operations on data stored in a database.

A multi-node database management system is made up of interconnected nodes that share access to the same database. Typically, the nodes are interconnected via a network and share access, in varying degrees, to shared storage, e.g. shared access to a set of disk drives and data blocks stored thereon. The nodes in a multi-node database system may be in the form of a group of computers (e.g. work stations, personal computers) that are interconnected via a network. Alternately, the nodes may be the nodes of a grid. A grid is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of the resources from a node is a server that is referred to herein as a “server instance” or “instance.”

### Hardware Overview

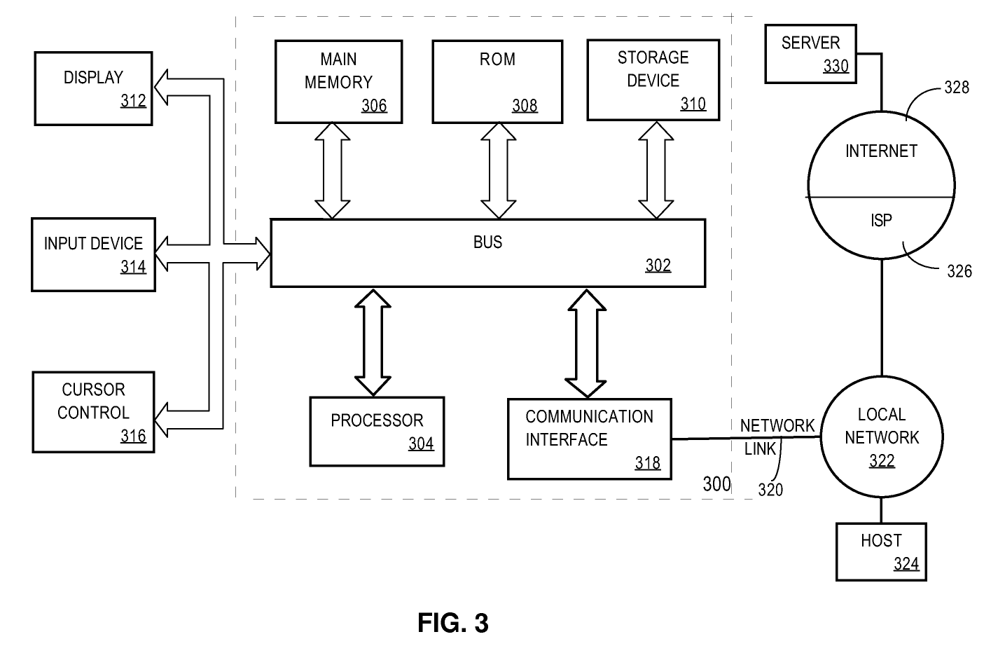

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to an embodiment of the invention, those techniques are performed by computer system 300 in response to processor 304 executing one or more sequences of one or more instructions contained in main memory 306. Such instructions may be read into main memory 306 from another computer-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 304 for execution. Such a medium may take many forms, including but not limited to, non-volatile media and volatile media. Non-volatile media includes, for example, optical or magnetic disks, such as storage device 310. Volatile media includes dynamic memory, such as main memory 306.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, or any other medium from which a computer can read.

Various forms of computer readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method, comprising:
storing a master table and a slave table;
wherein each row of a plurality of rows in said slave table corresponds to a row in said master table;
wherein said master table comprises master table partitions;
wherein said slave table comprises slave table partitions;
wherein each slave table partition corresponds to a master table partition;
wherein each row of said plurality of rows is stored in a slave table partition that corresponds to the maser table partition that stores the respective corresponding master table row;
receiving a query that requires access to said master table;
making a determination that said query requires access to only certain one or more master table partitions; and
in response to said determination:
pruning partitions accessed by computation of said query to said certain one or more master table partitions, and
pruning respective slave table partitions to the one or more slave table partitions that correspond to said certain document table partitions.

2. The method of claim 1, further including the step of rewriting said query to include a directive that specifies to prune any slave table partition that corresponds to a master table partition pruned for said query.

3. The method of claim 2, wherein the directive is function expression.

4. The method of claim 1, wherein said master table is partitioned based on a partition key contained in said master table.

5. A computer-implemented method, comprising:
storing XML documents in a XML document table;
storing an index table that indexes nodes of said XML documents;
wherein each row of a plurality of rows in said index table corresponds to an XML document and the row in said XML document table that stores said XML document;
wherein said XML document table comprises document table partitions;
wherein said index table comprises index table partitions;
wherein each index table partition corresponds to a document table partition;
wherein each row of said plurality of rows is stored in an index table partition that corresponds to the document table partition that stores the respective XML document of said each entry;
receiving a query that requires access to said XML document table;
making a determination that said query requires access to only certain one or more document table partitions; and
in response to said determination:
pruning partitions accessed by computation of said query to said certain one or more XML document table partitions, and
pruning respective index table partitions to the one or more index table partitions that correspond to said certain document table partitions.

6. The method of claim 5, further including the step of rewriting said query to include a directive that specifies to prune any index table partition that corresponds to an XML document table partition pruned for said query.

7. The method of claim 6, wherein the directive is function expression.

8. The method of claim 5, wherein said XML document table is partitioned based on a partition key contained in said XML document table.

9. The method of claim 5, further including the steps of:
storing said XML document in a particular row in a particular partition of the XML document table; and
in response to storing to said XML document in said particular row in said particular partition of said XML document table:
determining that a particular partition of the index table corresponds to said particular partition of said XML document table, and
creating entries in said particular partition of the index table that correspond to said particular row of said XML document table.

10. A computer-implemented method, comprising:
inserting an XML document in a particular row in a particular partition of an XML document table that stores XML documents;
wherein an index table indexes nodes of said XML documents;
wherein each row of a plurality of rows in said index table corresponds to a XML document and the row in said XML document table that stores said XML document;
wherein said XML document table comprises document table partitions;
wherein said index table comprises index table partitions;
wherein each index table partition corresponds to a document table partition;
wherein each row of said plurality of rows is stored in an index table partition that corresponds to the document table partition that stores the respective XML document of said each entry;
in response to storing to said XML document in said particular row in said particular partition of said XML document table:
determining that a particular partition of the index table corresponds to said particular partition of said XML document table, and
creating entries in said particular partition of the index table that correspond to said particular row of said XML document table.

11. The method of claim 10, further including the step of rewriting said query to include a directive that specifies to prune any index table partition that corresponds to an XML document table partition pruned for said query.

12. The method of claim 11, wherein the directive is function expression.

13. The method of claim 10, wherein said XML document table is partitioned based on a partition key contained in said XML document table.

14. The method of claim 10, further including the steps of:
storing said XML document in a particular row in a particular partition of the XML document table; and
in response to storing to said XML document in said particular row in said particular partition of said XML document table:
determining that a particular partition of the index table corresponds to said particular partition of said XML document table, and
creating entries in said particular partition of the index table that correspond to said particular row of said XML document table.
